(19) United States
(12) Patent Application Publication
(10) Pub. No.: US 2009/0022416 A1
(43) Pub. Date: Jan. 22, 2009

(54) REDUCTION OF COMPRESSION ARTEFACTS IN DISPLAYED IMAGES, ANALYSIS OF ENCODING PARAMETERS

(75) Inventors: IHOR OLEHOVYCH KIRENKO, EINDHOVEN (NL); RENATUS JOSEPHUS VAN DER VLEUTEN, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/279,063

(22) PCT Filed: Feb. 9, 2007
(86) PCT No.: PCT/IB07/50424

§ 371 Date: Aug. 12, 2008

(30) Foreign Application Priority Data
Feb. 15, 2006 (EP) 06101694.5

(51) Int. Cl. G06K 9/40

(52) U.S. Cl. 382/264

(57) ABSTRACT

A hither before unknown cause of image artefacts has been identified. Encoders such as MPEG encoders may use two picture structures: Field pictures and frame pictures. For a frame picture both frame and field-based DCT (and other types) of coding may be used. The decision whether to use frame or field based coding is not always made correctly. In the decoded image this leads to an image artefact visible as stripped blocks. The invention reduces, in one aspect of the invention, these artefacts by analyzing the block content on the presence of such artefacts and if the analysis proof the existence of such artefacts applying a vertical low pass filter to the data in the block. In another aspect of the invention encoding parameters are checked for combination of encoding parameters for which the artefact may occur and such blocks are indicated. The invention may be embodied in a method as well as in a device such as a receiver, encoder, decoder, display device etc.

The present invention relates to a method of processing a compressed image data stream in which method compression artefacts are reduced.

The present invention also relates to a reducer for reducing compression artefacts in a displayed decompressed image.

The present invention also relates to a receiver arranged for receiving a compressed image data stream for displaying an image, the receiver comprising a reducer for reduction of compression artefacts in a displayed decompressed image.

The present invention also relates to a display device comprising a receiver arranged for receiving a compressed image data stream for displaying an image, the receiver comprising a reducer for reduction of compression artefacts in a displayed decompressed image.

The present invention also relates to a transcoder for transcoding a compressed image data stream wherein the transcoder comprises a reducer for reduction of compression artefacts in a displayed decompressed image.

The invention also relates to a method for analyzing encoding parameters of an encoded image data stream and an analyzer for analyzing encoding parameters of an encoded image data stream.

Image display systems often receive compressed data streams. A variety of “lossy” video compression techniques are known to reduce the amount of image data that must to be stored or transmitted. Sophisticated compression schemes such as MPEG or Wavelet-based attempt to truncate spatial frequency information that is not crucial to perception of a viewer. With compression, image artefacts may appear in the decompressed image. Many schemes have been proposed to reduce image artefacts.

The inventors have noticed that, despite the known artefact suppression methods a particular image artefact is hardly reduced and persists. This artefact is present in the form of stripped bands in parts of the image. Known methods of artefacts suppression do not reduce this problem or have serious side effects.

It is an object of a first aspect of the invention to provide a method and a device such as a display device, receiver and/or transcoder as well as a reducer as described in the opening paragraphs in or by which a method for reduction of the mentioned image artefacts caused by compression is implemented.

To this end the method is characterized in that for a or for a group of decoded image blocks at least one difference value is determined from differences in pixel data in a vertical direction between adjacent lines and the difference value is compared to a threshold wherein in case the difference value meets the threshold, low pass filtering in vertical direction is applied to the decoded image block.

The invention is based on the following insight:

Modern image and video compression schemes such as MPEG use block-based processing. Each block consisting of 8-row by 8-column matrix of pixels is DCT transformed and quantized separately. According to the MPEG standard interlaced video picture might be encoded either as frame or field picture.

In frame pictures, both frame and field DCT coding may be used:

In the case of frame DCT coding, each block is composed of lines from the two fields alternatively.

In the case of field DCT, each block is composed of lines from only one of the two fields.

An MPEG encoder takes for each macroblock a decision whether frame or field DCT should be applied.

Motion prediction is also executed in two different modes: field and frame prediction. In the first case, predictions are made independently for each field by using data from one or more previously decoded fields. Frame prediction forms a prediction for the frame from one or more previously decoded frames.

Within a field picture all predictions are field predictions. However, in a frame picture either field prediction or frame predictions may be used (selected on a macroblock by macroblock basis). Therefore, for frame pictures the encoder can take two different decisions.

Ideally, MPEG codec should correctly determine whether frame or field processing has to be used and apply field DCT and motion prediction to originally interlaced material and frame processing to progressive material. In reality MPEG encoders do not always correctly make such a decision, especially for the input sources that contain interlaced film (thus, originally progressive) material. The artefacts are inherent to the standard coding. Though the quality of the MPEG encoder used may reduce the problem, the problem seems to persist even in high-end encoders.

If the MPEG encoder takes a wrong decision about using frame or field mode for a particular block or macroblock, artefacts will appear, which are localized within that block or macroblock. Those artefacts become especially visible at low bit-rate coding. The artefacts have a clear pattern: horizontal lines with one pixel width (and thus a vertical spatial wavelength of two lines), which are localized within block or macroblock (4 blocks). Pixel wide horizontal stripes (up-down-up-down) are visible, wherein the horizontal stripes span over a block or a macroblock. These artefacts are not, as many other artefacts, due to effects around edges, although they may be visible around an edge. The artefacts are also not to be confused with interlace errors which typically occur around moving edges and typically extend over many blocks. The artefacts the present invention aims to reduce are due to inherent errors in the encoding. The artefacts are due to wrong frame-field coding (DCT and/or motion prediction) for a frame picture. An error may be made each time a decision has been made for a block or macroblock between frame and field coding and may or may not be visible anywhere within an image at irregular positions. The characteristic artefact pattern due to such an error may be visible in the middle of an object or at an edge or anywhere else. The pattern may manifest itself anywhere. The above explanation is given with respect of MPEG coding. However, any other type of coding for which for frame pictures a choice is to be made between frame and field coding of blocks of macroblocks could result in the same artefacts in the displayed image. The invention is thus not restricted to MPEG encoded data streams, although it is of particular interest for MPEG encoded data streams.

The first aspect of the invention reduces the problem when present in decoded bit streams, by two simple basic steps:

In the first step a difference value is determined from pixel data differences in a vertical direction between pixels at adjacent lines within a block or macroblock. This first step comprises artefact detection based on local (i.e. within a block or macroblock) spatial (i.e. with or close to the particular spatial distance of a line) analysis of luminance and/or chrominance components, more in general pixel data, of the decoded image. Exemplary algorithms will be given below. Any algorithm that is capable of detecting a stripped pattern with a spatial zebra-like pattern of alternating lines (lines, which have lower correlation with adjacent lines than with the next nearest)(brighter, less bright, brighter etc) may be used. In general any detector and detecting step for detecting an equally (at least 1 pixel) thick ‘up-down-up’ pattern—e.g. by looking at two point differentials in pixels in adjacent lines will do. This may be a simple matter of subtracting pixel values and taking an average and comparing it to a threshold or may be more complicated e.g. taking a Hadamard transform, which looks at the presence of square-wave basic functions, and then determining the amount of energy in the 1-pixel wide base function in vertical direction and comparing this to a threshold which could be a fixed threshold but also for instance k times the amount of energy in the 2-pixel wide base function in vertical direction. The difference values may, depending on the algorithm, be expressed in various ways. All have in common that the difference value, or values if more than one difference values are determined, relates to the presence or absence of the stripped pattern, the presence or absence being determined from differences in a vertical direction between pixel data. Within the concept of the invention one or more difference values may be determined. It is preferred that a single value for the whole block or macroblock expressing the strength or likelihood of presence of the artefact is determined. However, the invention is not restricted to use of a single difference value, more than one difference value could be used.

The second step is artefact reduction, i.e. for those blocks in which the measured artefact, expressed by the difference value, exceeds a threshold a low pass filtering in vertical direction is applied to the decoded image block. The low pass filtering has a smoothing effect and thereby reduces the artefact. The first step is thus artefact recognition, the second step is artefact reduction by using a low pass filter.

The low pass filtering is only applied if the difference value meets the threshold. Thereby unnecessary low pass filtering, which would unnecessarily reduce detail in the image, is avoided.

In embodiments of the invention the determination of the difference value is preceded by a selection step to select the blocks on which the difference value determination and low pass filtering is to be performed.

Difference value determination and low pass filtering require calculation power. Low pass filtering will cause some loss of details. By selecting the blocks, i.e. identifying those blocks in which the problem is most likely to occur and/or most likely to have a noticeable effect on image quality and for other blocks bypassing the difference value determination and low pas filtering, loss of details may be avoided while yet reducing the required calculation power and maintaining efficiency.

In embodiments the selection is performed on the basis of an average luminance or average color content of the block. The human eye is most sensitive to bright colors and is very sensitive to skin colors. In such embodiments the decision whether or not to select the blocks is taken on the assumption that the effect, although it may be visible, will be most annoying in certain circumstances and/or parts of the image, e.g. in a face, and much less in other circumstances and/or parts of the image, e.g. on a grassy field. More in general those blocks that most likely will be of less importance to the perceived overall quality of the image are exempt from the difference value determination and low pass filtering.

In other embodiments the selection comprises a consistency check performed with neighboring blocks. A consistency detector checks whether the detected zebra-like pattern is restricted to within the block or whether it continues along neighboring blocks. Patterns that are present in a number of neighboring blocks and also of the same type (e.g. the same average grey value and the same difference in grey value) may point to a real object pattern for instance of a fence.

In yet other embodiments the selection step comprises a step in which encoding parameters of the blocks are analyzed.

In this embodiment during the selection step encoding parameters, e.g. the particular set of flags of bitstream headers, are analyzed. As explained above, the artefacts are due to a wrong frame/field coding decision. These headers are present in the encoded bit-stream. Data in the headers indicate whether or not the encoder may have taken a wrong decision or not. When the data in the headers indicate that there is no such possibility, there is no reason to take the next steps of determining the difference value and low pass filtering, since the following steps would require calculation power and may reduce details. When the data do indicate the possibility of a wrong frame/field coding decision, the block is further processed.

The above mentioned various types of selecting steps may be combined to further reduce the required calculation power while yet efficiently reducing the artefacts without unduly smoothing the image.

The threshold may be a fixed threshold or may be dependent on data comprised within the block. Data comprised within the block may be for instance the average luminance. The threshold may for instance be dependent on the average variation in luminance in all directions. If the average variation in luminance is high in all direction, or in other words a noisy image or an image with many details is present, the variation in horizontal direction will likely also be large. In yet another embodiment the variation at a distance of 1 pixel is compared to the variation at two pixel distance. The artefacts that the present invention seek to overcome show a large variation in luminance or/and chrominance between adjacent lines, between odd and even lines, within a block, but no or hardly any variation between odd or even lines.

The first aspect of the invention provides for a simple and robust method for reducing compression artefacts in the decoded image.

Experiments have shown that the zebra-pattern artefacts are effectively reduced, without unduly negative effects on other image features even with simple algorithms.

The display device, receiver and/or decoder, encoder or transcoder, more in general any device in accordance with the first aspect of the invention comprises a reducer for performing an algorithm in accordance with the first aspect of the invention.

The invention may be implemented in various ways and thus in various devices depending on the implementation.

The invention is, in embodiments, implemented in a video post-processing chain, where information from the encoded stream is not available. In other words, the algorithm used in such an embodiment of the invention processes already decoded image data and does not require any coding parameters. The possible application is high-end TV, multimedia centers, and any other video processing devices, where input signal is a decoded video sequence.

The invention can be embodied in a method as well as in a display device, a receiver, a transcoder etc.

The invention may also be implemented at the encoder side. When implemented at the encoder side, or more in general at any point where encoding parameters are available an additional algorithm may be used in the encoder to check for instances in which the wrong frame/wrong field encoding has been or may have been performed.

At the encoder side this aspect of the invention may be used for indicating where correction of the artefact is useful. This may be used to correct an already encoded signal before it is sent.

A second aspect of the invention is a method of analyzing the encoding parameters wherein blocks or macroblocks in a frame picture for which the encoder may have performed a frame or a field encoding are indicated.

This aspect of the invention may e.g. be used for post-validating to change the encoding decision to eliminate the problem rather than, as is the case when the invention is on an encoded data stream, reduce the negative effects of a wrong frame/field encoding.

This second aspect of the invention, analyzing the encoding parameters to indicate blocks that may show the artefact is based on the same basic insight upon which the first aspect is based, namely the insight that present coding standards such as MPEG open the possibility of the above described artefact due to wrong frame/field coding decisions taken by the encoder. Some of the artefact reduction methods described may be performed on decoded data streams without any knowledge of how the encoding and decoding have been performed. In such methods and devices all blocks of the decoded image data stream are analyzed. By analyzing the headers when they are still available it is possible to indicate the blocks wherein the artefact may occur so that the artefact reduction methods may be performed more economically since the blocks that are not effected by the artefact need not undergo an artefact reduction step. The method for analyzing the encoding parameters and the corresponding analyzer as well as any device comprising an analyzer or using or for use of the encoding parameters analyzing method is also novel and inventive and directed to the problem namely as a first step in solving the problem. The analyzing method also provides a novel product namely an image data stream or a signal comprising an image data stream, the image data stream or signal comprising indicators of potentially affected blocks and/or or blocks having an indicator and/or an indicating signal.

The analyzing method may form part of an artefact reduction method in which case both aspects of the invention are combined.

Both aspects of the invention may, however, be used separately.

In essence the first aspect (pattern recognition followed by artefact reduction) is a remedy for the problem, independent of an actual diagnostic of the used encoding which may cause the problem. The second aspect (analyzing) analyses the encoding parameters to identify possibly problematic blocks. The information gathered by the analyzing method is useful, whether this information is used in a method in accordance with the first aspect or in any other method or simply registered.

The method in accordance with the second aspect may be followed by a method in accordance with the first aspect or any other remedial method at the encoder or decoder end, or may simply be used for diagnostic purposes, e.g. to find the possibly problematic blocks or find the percentage of problematic blocks. It could for instance be used for diagnostics of MPEG encoders. Being able to identify which MPEG encoders are most liable for artefact production is very useful and a first step in developing MPEG encoders that do not produce the artefact.

These and further aspects of the invention will be explained in greater detail by way of example and with reference to the accompanying drawings, in which

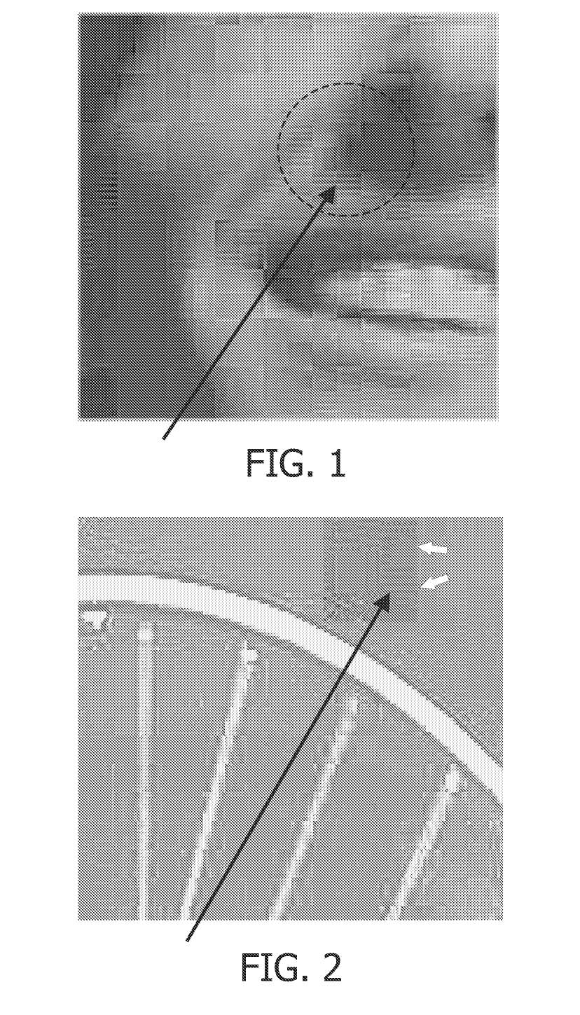

FIGS. 1 and 2 schematically illustrate the artefacts the present invention aims to reduce.

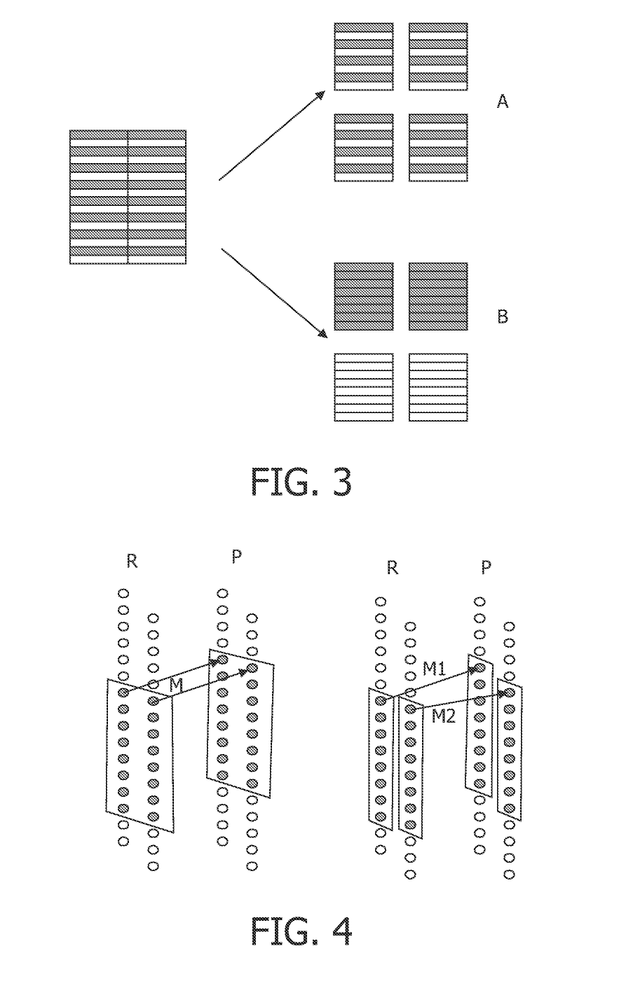

FIG. 3 illustrates DCT coding of a macroblock.

FIG. 4 illustrates motion prediction.

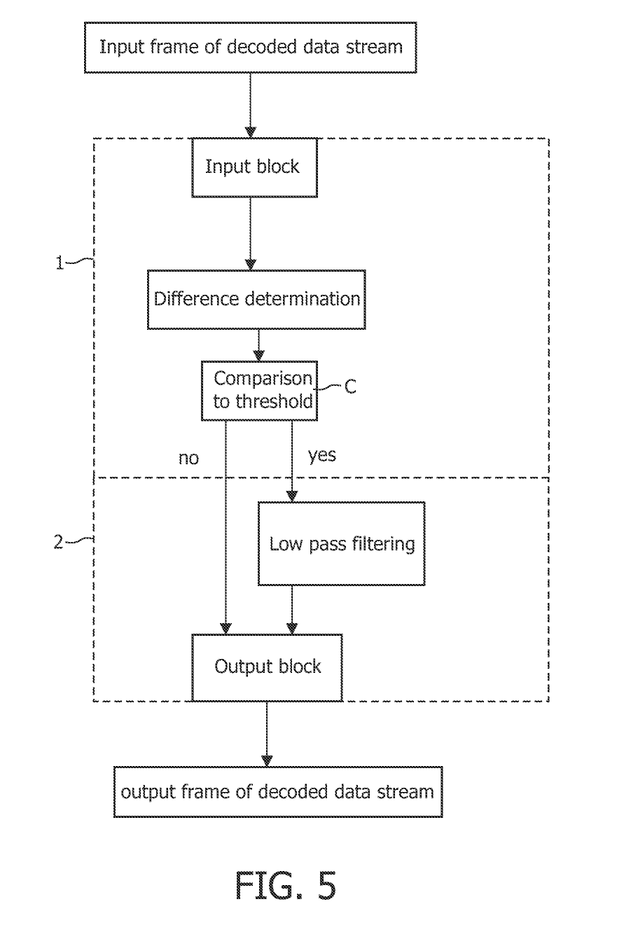

FIG. 5 schematically illustrates a method in accordance with the first aspect of the invention.

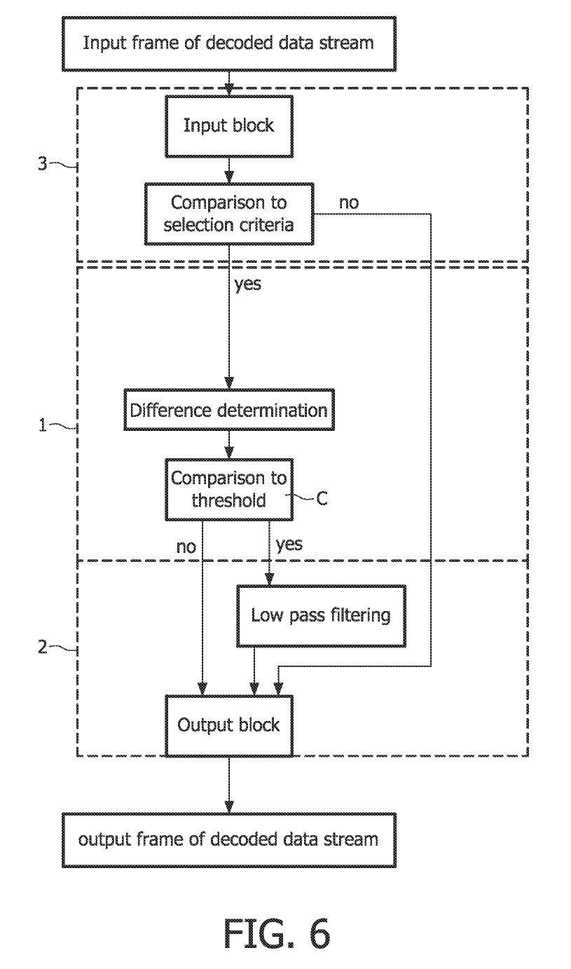

FIG. 6 illustrates an embodiment of a method in accordance with the first aspect of the invention.

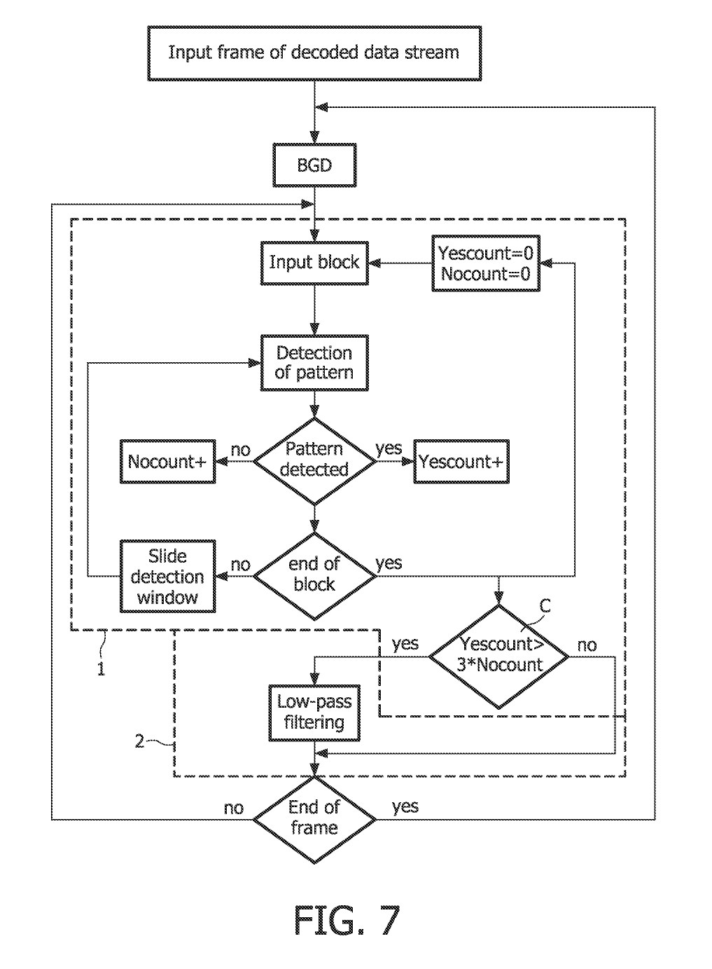

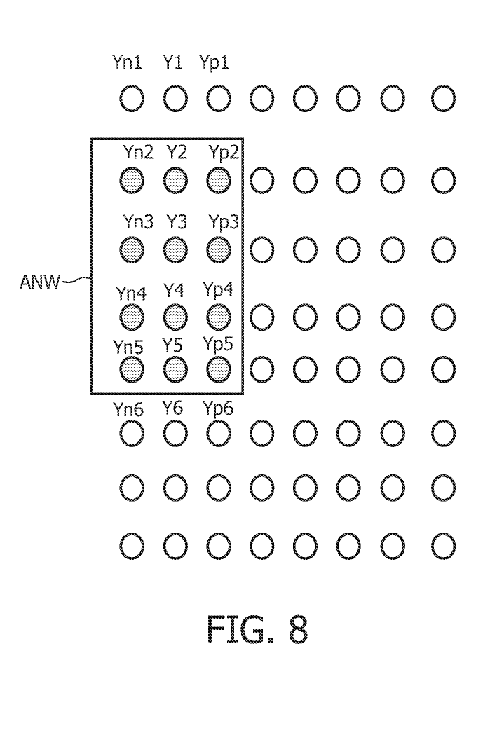

FIGS. 7 and 8 illustrate further embodiments in accordance with the first aspect of the invention.

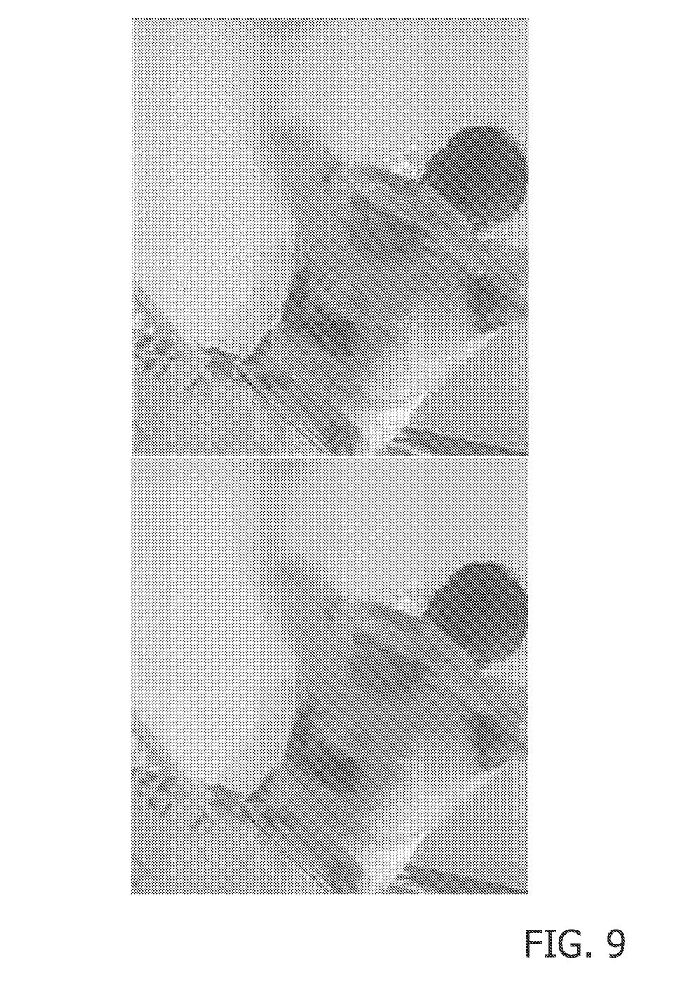

FIG. 9 illustrates the effect of the invention.

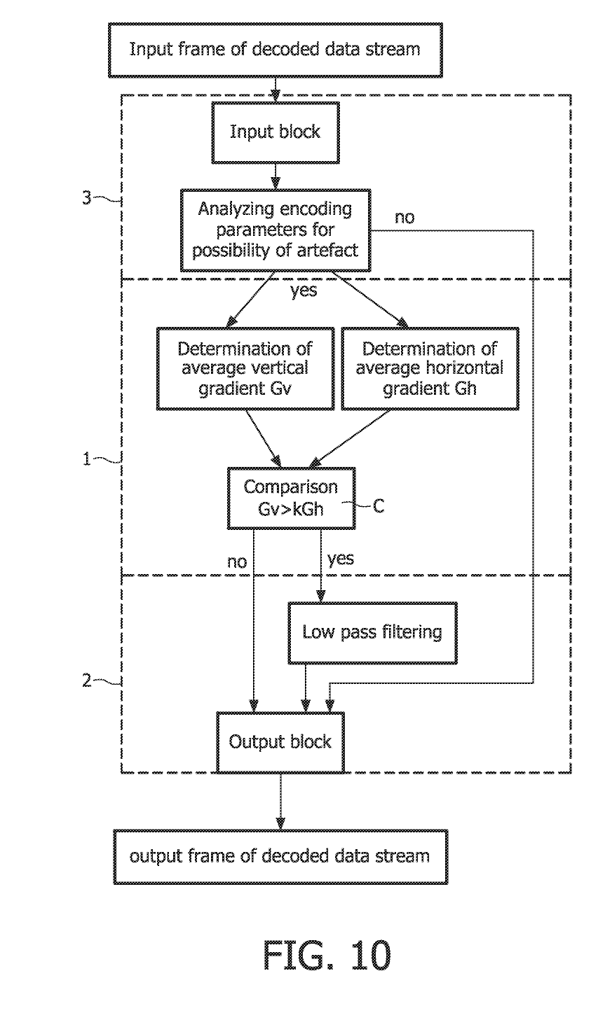

FIG. 10 illustrates another embodiment of the invention.

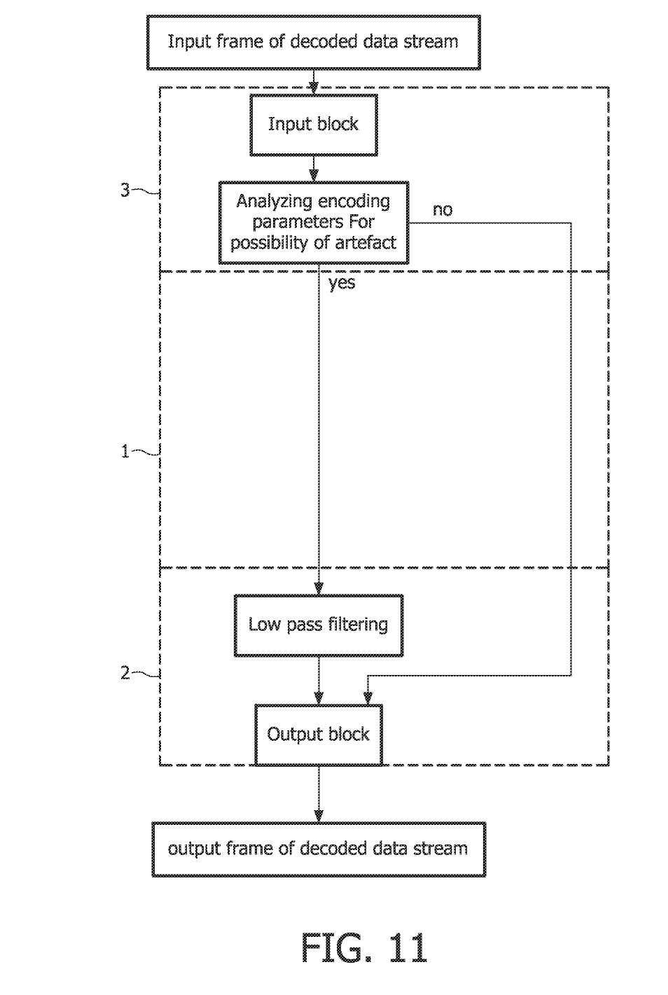

FIG. 11 illustrates a method in accordance with the second aspect of the invention.

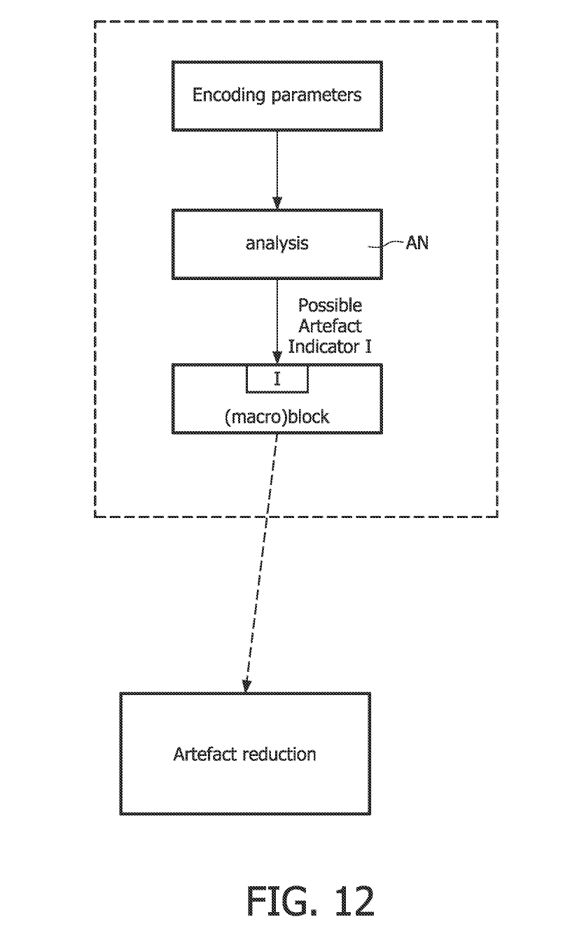

FIG. 12 schematically illustrates a method in accordance with the second aspect of the invention.

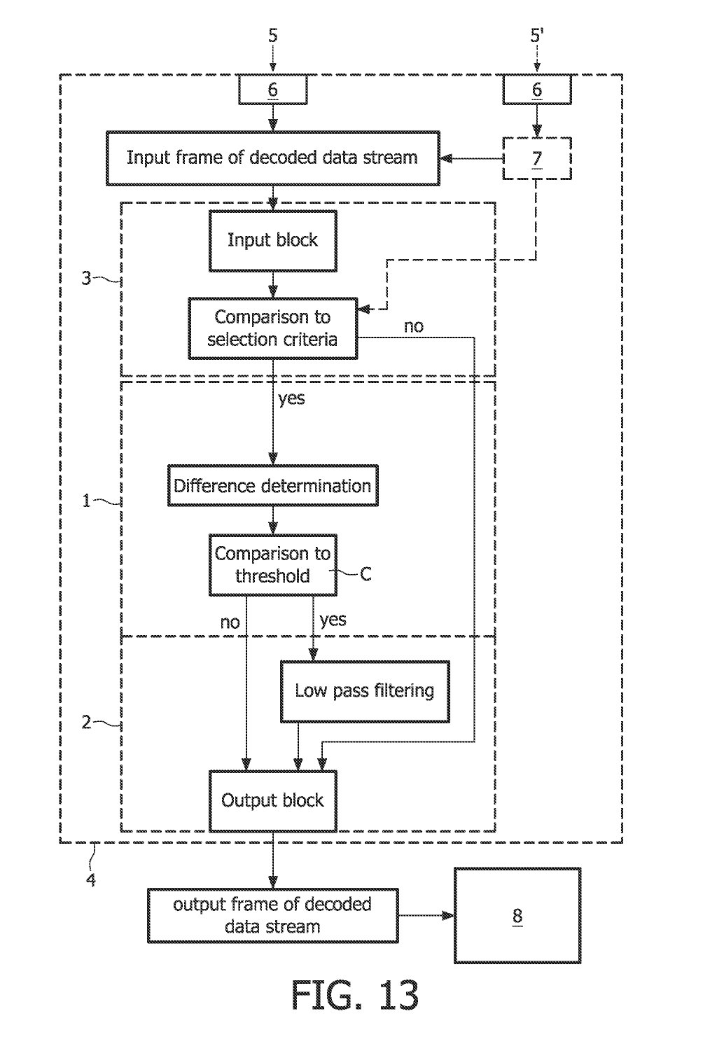

FIG. 13 schematically illustrates a display device in accordance with the invention.

The Figs. are not drawn to scale. Generally, identical components are denoted by the same reference numerals in the Figs.

The present invention in its various aspects will now be described more fully hereinafter with reference to the accompanying drawings, in which preferred embodiments of the present invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Compression techniques are often used to compress the data stream, i.e. reduce the amount of data within the data stream. In particular, consumer recorder devices (DVD recorders, hard-disk recorders etc.) use digital compression algorithms to provide digitally compressed streams such as MPEG2 streams. Such compression techniques may be loss less techniques, but often, when an appreciable amount of compression is used, some loss of data is deemed acceptable. Typically data compression techniques are arranged such that the loss in data is kept relatively small so that not much visible effect of the data compression is seen in the decompressed displayed image. However, especially with high compression ratios, image artefacts may appear in the decompressed image. One of such artefacts is a zebra-like pattern, in which anywhere in an image spurious zebra-like patterns occur. Hither before the nature and reason for these spurious zebra-like patterns was unknown. These artefacts may appear anywhere in the image, independent of the presence or absence of an edge feature and in the absence of any indication of possible interlace errors or in patterns inconsistent with interlace errors or in fact of any other known cause of compression artefacts.

FIGS. 1 and 2 schematically illustrate these artefacts.

The Figs. are in black and white since such is mandatory for patent applications. Block-wise vertical striations are visible indicated by the arrows. In an actual color image such striations are even more visible than in black and white. These striations form zebra-like patterns in block form. Throughout the image such striations are visible. These striations do not seem related to the presence of an edge or other feature in the image, and may be formed in areas with no other features. In some of the blocks the striations are clearly visible; in others they are completely absent. The patterns are not restricted to those areas where, in case there would be interlace errors, one would expect interlace errors to occur. Thus, checking for known causes of artefacts one does not find such a known cause. An aspect of the invention is that the inventors have realized that the artefact is due to a hither before unknown cause. They realized that standard encoding techniques such as MPEG may cause these artefacts, even in the absence of all other known causes of artefacts. This insight is a novel insight on which the invention is based.

Modern video compression schemes such as or MPEG use block-based processing. Each block consisting of 8-row by 8-column matrix of pixels is DCT transformed and quantized separately. According to MPEG standard an interlaced video picture might be encoded either as a frame or a field picture. In frame pictures, both frame and field DCT coding may be used:

In the case of frame DCT coding, each block is composed of lines from the two fields alternatively.

In the case of field DCT coding, each block is composed of lines from only one of the two fields lines.

FIG. 3 illustrates DCT coding of a macroblock. The DCT coding can be either frame coding (part A of FIG. 3) or field coding (part B of FIG. 3).

The MPEG encoder takes for each macroblock the decision whether frame or field DCT should be applied.

Motion prediction is also executed in two different modes: field and/or frame prediction. In the first case, predictions are made independently for each field by using data from one or more previously decoded fields. Frame prediction forms a prediction for the frame from one or more previously decoded frames. Within a field picture all predictions are field predictions. However, in a frame picture either field prediction or frame predictions may be used (selected on a macroblock by macroblock basis).

FIG. 4 schematically illustrates frame and field motion prediction. In frame prediction (A′) only one motion vector M is used to predict motion from a reference frame R a predicted frame P. In field prediction two motions vectors M1 and M2, one for each of the fields, are used. These motions vectors M1 and M2 may differ as schematically shown in the example of FIG. 4.

Ideally, MPEG codec should correctly determine whether frame or field processing has to be used and should apply field DCT and motion prediction to interlaced material and fame processing to progressive material. In reality, however, low-cost (and thus low-quality) MPEG encoders do not always correctly make such a decision, especially for the input sources, which contain interlaced film material. Even in high end MPEG encoders incorrect decision are frequent.

If the MPEG encoder takes the wrong decision about using frame or field mode for a particular macroblock, image artefacts will appear, which are localized within that macroblock. Those artefacts become especially visible at low bit-rate coding. FIGS. 1 and 2 show some examples of such artefacts. As can be seen, the artefacts have a clear pattern: horizontal lines with one pixel width, which are localized within a block or macroblock (4 blocks). The invention is aimed at reducing these artefacts or at least providing means enabling reduction of these artefacts. The same or similar artefacts occur when a wrong decision is taken for motion prediction.

FIG. 5 illustrates a method in accordance with a first aspect of the invention. It also schematically illustrates a reducer in accordance with the invention. Blocks or macroblocks of an input frame are, in part 1 of the reducer corresponding to step 1 of the method analyzed. In this first step 1 a difference value between pixels at adjacent lines within a block or macroblock determined. “Difference value” is to be interpreted broadly as being any number that expresses the differences in luminance and/or chrominance between pixels at adjacent lines. Several examples of such difference values will be given herein below. The difference value is compared to a threshold in a comparator C. If the difference value meets the threshold value low pass filtering in a vertical direction is applied on the block or macroblock in a low pass filter. If it does not meet the threshold no low-pass filtering is applied. The determination of the difference value and comparison to the threshold is equivalent to detection of the presence of the zebra-like pattern. The low pass filtering is only applied to those blocks for which the pattern is detected. The method is thus comprised of a block wise pattern detection followed by low pass filtering for those blocks in which the pattern is detected in the decoded signal. An output frame of the decoded data stream is made. This output frame is e.g. sent to a display device or recorded on a recording medium.

FIG. 6 illustrates an embodiment of the invention. In this embodiment a selection step 3 is performed in selector 3 prior to the pattern detection is step 1. The selection may be performed along different lines. The selection aims to reduce the required calculation power and/or reduce negative side effects of the low pass filtering by identifying blocks for which low-pass filtering is not or less useful.

In a first type of embodiments the selection is performed based on the insight that the human eye is more sensitive to certain colors and/or certain areas within the image. Blocks to which the human eye are relatively insensitive and/or to which the attention is not drawn are exempt from the following steps for reducing the required calculations. For instance, a color determination could be applied to a block to determine the average color of a block. For certain colors, such as flesh colors, the block is made an input for step 1, whereas for other colors such as blue (sky) and green (grass), the block is not an input for step 1 and bypasses steps 1 and 2. A viewer tends not to direct its attention to the sky or to a gassy field. A viewer also tends to concentrate its attention to the middle part of the screen. Thus, artefacts at the edges of the screen are less conspicuous than at the center. A criterion could thus be the position in the image. Blurred parts of an image draw less attention than in-focus parts of an image. Therefore the sharpness of the part of the image to which the block belongs may be a criterion.

In a second type of embodiments information on the encoding of the data stream is present. In the selection step the encoding parameters are checked, for instance by means of analyzing picture headers of the encoded data stream, to identify blocks that may comprise the artefact.

In this embodiment during the selection step 3 encoding parameters, e.g. the particular set of flags of bitstream headers are analyzed. As explained above, the artefacts are due to a wrong frame/field coding decision for a frame picture. Data in the headers indicate whether the encoder may have taken a wrong decision or not. When the data in the headers indicate that there is no such possibility, there is no reason to take the next steps, since such following steps would only require calculation power and may reduce details without any beneficial effect to be expected. When the data do indicate the possibility of a wrong frame/field coding decision, the block is further processed. This embodiment can be used for all those instances and devices in which encoding information is available. It will below be explained that analyzing the encoding parameters to indicate blocks that may show the artefacts forms in itself a second aspect of the invention, which may be used independently of the first aspect.

In a third type of embodiments a consistency check is performed with neighboring blocks. This comparison may be done prior to pattern recognition step 1, or within pattern recognition step 1. A detector embodiment checks whether zebra-like patterns are restricted to within the block or whether they continue along neighboring blocks. Patterns that are present in a number of neighboring blocks and also of the same type (e.g. the same average grey value and the same difference in grey value) may point to a real pattern for instance an image of a fence. Such blocks may either be exempt from steps 1 and 2, if the consistency check is performed as a selection step 3, or, if the consistency step is performed within the pattern recognition step 1, low pass filtering 2 is not applied, despite the fact that the difference value meets the threshold.

FIGS. 7 and 8 illustrate an embodiment of the invention.

FIG. 7 shows the block scheme of the algorithm. It comprises two parts, pattern detection, indicated by the area 1 within the dotted lines, and artefact reduction, indicated by the area 2 within dotted lines. A yes count value is established, whereby thus a difference value, namely the yes count, is determined. This is compared to a threshold, in this case the threshold being 3*no count. If the difference value, i.e. the yes count, meets the threshold, i.e. yes count>3nocount, low pass filtering 2 is applied, if not, low pass filtering 2 is not applied.

At the beginning, Block Grid Detection (BGD) is executed for an input frame in order to find the location and size of the DCT block grid. Then, for each block, the presence or absence of the artefact is detected. This is achieved by detecting the particular spatial pattern within a sliding analysis window ANW. This analysis window ANW is shown in FIG. 8. By means of sliding the analysis window ANW all pixels within the block are scanned and analyzed starting from the left top corner of the block and ending in right bottom corner. The center of the analyzed window within FIG. 8 is a pixel pair Y3 and Y4. The algorithm decides whether the difference in pixel value delta between pixels Y3 and Y4 is most likely an object edge or a possible artefact. This is achieved by detecting the presents of the artefact pattern (horizontal lines with one pixel width, which are localized within block or macroblock (4 blocks)). When it is decided that the difference is most likely an artefact the yes count is increased by one, if it is decided that this is not the case, the no count is increased by one. Both the yes count and no count are set to zero at the beginning of scanning a block or macroblock. The yes count is thus the output of the determinator for determining the difference value, the no count the output of the determinator for determining the threshold wherein in this example the determinator for the difference value and the threshold have elements in common. This pattern detection technique is for instance implemented in the following way:

delta= |Y3 − Y4| ;
D32 = |Y3 − Y2| ;
D45 = |Y4 − Y5| ;
D24 = |Y2 − Y4| ;
D35 = |Y3 − Y5| ;
if( delta<T1 and D35<T2 and D24 < T2 )

(1)

{
if ( ( D24 < D32 or D24< delta ) and ( D35 < D45 or D35 <
delta ) and

(delta >|Yn4 − Yp4| or delta >|Yn3 − Yp3| ) ) (2)

{
if ( ( D35 < delta or D24< delta) or |Y2−Y5|< delta)

(3)

yes count ++ ; /* the error pattern is detected */

else

no count ++ ; /* the error pattern is not detected */
}
}

This is the algorithm executed in this example schematically shown in FIG. 7.

In experiments T1 was 25, and T2 was 5;

The yes count is thus a difference value expressing for how many pairs of pixels in adjacent lines show a pixel data difference delta=|Y3-Y4|, which, taken into account other pixel value differences such as D24 etc, points to the possible existence of the zebra-like pattern. The difference value yes count, which expressed the strength of or likelihood of presence of the artefact is then compared in a comparator C to a threshold, in this example 3*no count. If the difference value yes count meets the threshold 3*no count low pass filtering is applied. If this is not the case, no low pass filtering is applied.

It is noted that the above conditions are particular examples of the pattern detection mechanism. Although experiments have shown that the above conditions (found empirically) provide good results, a skilled person might come up with different conditions, which will provide similar results. Therefore, the particular description of conditions (1)-(3), although very useful, should not be interpreted to limit the scope of the invention. The generalized idea of pattern detection step of the proposed algorithm is to detect (interlaced) horizontal lines localized within a block with almost equal gradient within this block. The pattern detection step comprises a value determination step and a comparison step.

In case a video processing system has enough computational and memory resources, the robustness of the error pattern detection mechanism can be increased by applying the above described method to chrominance components as well as to luminance components.

According to the block-scheme of the exemplary algorithm, if the artefact pattern is detected in the current analysis window ANW, the value of the counter yes count is increased by one, otherwise, the counter no count is increased. After that, the analyzed window is shifted by one pixel, and the pattern detection algorithm is applied to a new pair of pixels. When all pixels within block are scanned and analyzed, a decision about the presence of the error in this block by comparing the accumulated values of yes count and no count. If yes count>k*no count, then the artefact is present in this block. The parameter k regulates the robustness of the detection. In an embodiment of the invention, k=3.

If the artefact is detected within the current block, the next step of the algorithm, removal of the artefact, is executed in step 2. In an embodiment of the invention, this artefact reduction is achieved by means of simple low-pass filtering in vertical direction (perpendicular to horizontal stripes of the artefact). Generally, the strength of the low-pass filtering might be chosen adaptively to the magnitude of the errors (e.g. average magnitude of vertical gradients between horizontal stripes) and uniformity of pixel values in horizontal direction (within the stripes). In this case the strength parameter can be defined or adjusted using empirically created LUT.

In an experiment a non-adaptive filtering with fixed parameters has been used:

Y3′=(Y2+Y3*3+Y4)/5;

Y4′=(Y3+Y4*3+Y5)/5;

The efficiency of the exemplary embodiment of the invention was evaluated by carrying out a set of experiments. More than 10 test sequences encoded with low bit rate were used in the experiments. The efficiency of the algorithm was estimated subjectively.

FIG. 9 shows the example of decoded frame before and after processing by the proposed algorithm, wherein the ‘before’ image is given at the top and the ‘after’ image at the bottom half of FIG. 9. In the experiments the simplified version of the algorithm was used, without adaptation of low-pass filtering. A very significant decrease of the artefacts is visible.

The proposed exemplary algorithm efficiently reduces the artefact and, at the same time, preserves object edges. Due to the small size of the analyzing window, the hardware implementation of the algorithm requires only 3 lines of memory.

FIG. 10 illustrates another embodiment of the invention. The algorithm comprises, as in previous Figs., artefact detection step 1 of and artefact reduction step 2 by means of low pass filtering.

In the detection part 1 a spatial analysis of potentially affected macroblocks (detected in a preceding step 3) is performed in order to confirm the presence of the artefacts and select macroblocks, in which those artefacts are visible.

During the reduction part 2 of the proposed algorithm, the artefacts in the detected macroblocks are removed by means of adaptive 1D spatial low-pass filtering.

The detection part is preceded by a selection stage 3 in which encoding parameters are analyzed, e.g. using an analysis of sequence headers and picture headers of the encoded video bitstream, for detection of blocks or macroblocks which may potentially contain this type of artefacts. Such blocks are further analyzed. Blocks for which the analysis of the sequence headers and picture headers reveal that the artefacts are not possible or at least highly unlikely are not further analyzed and are not low pass filtered.

During the selection step 3 of the preferred embodiment of the invention the particular set of flags of bitstream headers is checked, which will indicate whether the encoder may have taken a wrong decision in frame pictures about application of frame/field processing. In this selection step encoding parameters are analyzed to indicate potentially affected blocks.

The following encoding parameters are for example checked:

progressive_sequence (PrSe) flag in the sequence extension header—When set to “1”, the coded video sequence contains only progressive frame-pictures. If this flag is set to “0” the coded video sequence may contain both frame-pictures and field-pictures, and frame-Picture may be progressive or interlaced frames.

Picture_structure (PiSt) flag in the picture extension header. If this flag is set to 11, then the picture is encoded as frame_picture, if flag is set to 01 or 10, then the picture is encoded as field_picture.

Frame_pred_frame_dct (fpfd)—If this flag in the picture extension header is set to “1”, then only frame DCT and frame predictions are used for all macroblocks in the frame. Otherwise, frame as well field DCT and predictions may be used within frame.

Frame_motion_type (fmt) flag in the macroblock modes header—when set to 10, the macroblock uses frame based prediction. If the flag is set to 01, the macroblock uses field-based prediction.

Dct_type (dt) This flag in the macroblock modes header indicates whether the macroblock is frame DCT coded or field DCT coded. If this is set to “1”, the macroblock is field DCT coded.

If flag fpfd is set to 1, then flags fmt and dt are omitted from the bitstream, and by default frame-based DCT and predictions are used.

Ideally, during encoding of movie material by DVD recorder, the flag fpfd should be set to 1 and then only frame-based processing will be applied during encoding, and thus no frame/field errors, as described above, will occur. Unfortunately, it is not always the case, and very often the flag fpfd is set to “0” and then encoder decides situation was noticed even in professionally mastered DVDs, not to mention home-made DVDs recorded on low cost consumer DVD recorders. If an encoder takes a wrong decision for particular macroblock, then artefacts might occur when the sequence will be displayed as originally progressive.

In this preferred embodiment of the invention macroblocks which are vulnerable for such artefacts, or in other words, where the encoder may have taken a wrong decision are identified and selected for further processing. Macroblocks are potentially affected when the above described header flags take the following values:

{ progressive_sequence (PrSe) == 0;
Picture_structure (PiSt) ==11;
Frame_pred_frame_dct (fpfd) ==0;
}
and
{ Frame_motion_type (fmt) ==01;
or
Dct_type (dt) == 1;
}

At the next step of the process spatial analysis is applied to the blocks or macroblocks, which were identified and selected as being “potentially affected”. This analysis is in this example implemented by means of comparison between average gradients of pixel pairs in horizontal and vertical directions within the block. For the example shown in FIG. 8, the average vertical gradient for 8×8 block

$$Gv = \frac{{\sum }_{i = 1}^{8} {\sum }_{j = 1}^{7} \vert {y}_{j , i} - {y}_{j + 1 , i} \vert}{56}$$

and the average horizontal gradient

$$Gh = \frac{{\sum }_{i = 1}^{7} {\sum }_{j = 1}^{8} \vert {y}_{j , i} - {y}_{j , i + 1} \vert}{56}$$

We assume that the artefact within 8×8 block is visible if Gv>k*Gh.

Normally k=2.

In this example the difference value is thus Gv and the threshold is k*Gh.

This is by no means the only possible comparison; one could for instance also calculate the average two-pixel gradient Gv2 and compare this to Gv

$$Gv 2 = \frac{{\sum }_{i = 1}^{8} {\sum }_{j = 1}^{6} \vert {y}_{j , i} - {y}_{j + 2 , i} \vert}{48}$$

The comparison is then Gv>k*Gv2. The determinator for determining the difference value thus comprises the calculator for calculating Gv, the determinator for determining the threshold value comprises the calculator for calculating Gh or Gv2, the comparator compares Gv to k*Gh or k*Gv2.

During the artefact reduction part of the algorithm ID adaptive low-pass filter is applied to all pixels from the blocks that are selected in step 3 and fall under the condition set in step 1 (Gv>kGh). The low-pass filter smoothes pixels in vertical direction. In this example the strength of the filter depends on the value of the average horizontal gradient Gh in this block:

$${y}_{i , j} = \frac{{y}_{i - 1 , j} + ( 1 + f ( \frac{Gh}{k} ) ) * {y}_{i , j} + {y}_{i + 1 , j}}{3 + f ( \frac{Gh}{k} )}$$

where yᵢⱼ is the filtered output pixel and f(Gh/k) stands for a function which increases as Gh increases and decreases as k increases. It is to be noted that when f(Gh/k)=2 the above formula is comparable to the previously given simple non-adaptive filter. This example exemplifies a preferred embodiment of the invention in which the strength of the low pass filtering is dependent on data comprised in the block, in this example on the value of Gh. If Gh is larger the factor f(Gh/k) becomes larger and the smoothing effect and thereby the low pass filtering becomes weaker. In this example the reducer thus comprises a further determinator to determine the strength of the low pass filter in dependence on data comprised in the block. The further determinator is comprised of the determinator of Gh and the algorithm for expressing the strength of the filter as a function of Gh.

The scope of the patent is not limited by any particular method of low-pass filtering. A skilled person might come up with other low-pass filters which are adaptive to a local spatial activity and/or visibility of the artefact.

It is remarked that the method may be applied to a whole image or to a part of the image. Within embodiments different versions of the algorithm of the invention may be applied to different parts of the screen. For instance a high power version may be applied to a central part of the screen, whereas a more simple version may be applied to less important part of the screen.

The method of analyzing encoding parameters described above in relation to step 3 is described above in relation to FIG. 10 as a first step in the artefact reduction method. The artefact reduction method can be seen as a remedy to the problems that wrong frame/field coding has caused.

The method of analyzing encoding parameters to indicate potentially affected blocks may be used separately and independently and is in itself an aspect of the invention. Within the framework of the invention “identification” and “indication” are equivalent and covered under the term “indication”. Indication allows those blocks that are potentially affected to be distinguished from the blocks that are not potentially affected. The analyzing method forms a diagnostic tool to find those blocks which are potentially affected by the artefact. The artefact reduction method and the method of analyzing encoding parameters are thus directed to the same problem and based on the same insight. Whereas the artefact reduction method provides a reduction of the problem, the method of analyzing provides an identification of potentially affected blocks. The two methods can be used separately or in combination. Although the scopes of claims directed to these two aspects of the invention differ, both aspects are based on the same insight, and are directed to the same problem and both are novel and inventive. FIG. 11 illustrates a method for reducing artefacts in which the encoding parameters are identified. The difference between the method schematically shown in FIGS. 10 and 11 is that step 1 (calculation of difference value and comparison to a threshold) is not present in FIG. 11. By analyzing the encoding parameters, the blocks that are potentially affected are indicated. The blocks that cannot have been affected by the artefact do not undergo a low pass filtering. The blocks that may have been affected undergo low pass filtering. Low pass filtering has the draw back of a potential reduction in detail. Indiscriminate low pass filtering of all blocks of a decoded data stream, without any knowledge of the encoding parameters, and without checking the presence of the artefact, would thus most likely do more harm than good. Therefore in the method of FIG. 5 artefact detection step 1 is present. However, if those blocks that are potentially affected are indicated, low pass filtering may be applied selectively, namely only to those blocks that are potentially affected by the artefact and thus the amount of harm is strongly reduced. This would allow a simplification of the method in which all potentially affected blocks are low pass filtered without a preceding step to determine a difference value and compare the difference value to a threshold. Such a simplified method is schematically shown in FIG. 11. Although the simplified method of FIG. 11 might be somewhat less effective than a method as shown in FIG. 5 due to the absence of step 1, the simplified method would still be better than doing nothing or than indiscriminately low pass filtering all blocks.

FIG. 12 schematically illustrates the method of analyzing the encoding parameters. The encoding parameters are analyzed in analyzer AN. If the coding parameters indicate the potential of artefacts, an indicator I is associated with the block or macroblock for which a combination of encoding parameters is found indicating possible occurrence of the artefact, i.e. an indicator to indicate the possibility that wrong frame/field encoding may have been performed. Such blocks may then later be subjected to an artefact reduction method with or without a preceding determination of a difference value. “Associated with” is to be understood within the concept of the present invention that there exists a link between the image data streams and the indicators. The indicators I may be inserted into the data stream for instance as headers or flags. In such embodiments the indicators I are comprised in the image data stream. This thus provides for a new product namely an image data stream or a signal comprising an image data stream which signal comprises indicators I indicating for blocks or groups of blocks the possibility a wrong frame/field encoding. The indicators I may also be comprised in a data stream separate from but linkable to the image data stream. Such may be for instance a short signal preceding or following the actual data stream in which a list is provided of possible affected blocks or groups of blocks. Such a signal for an image data stream also provides for a novel product. The artefact reduction method may be an artefact reduction method as described above and as claimed. However, this is not mandatory for the analyzing method. The analyzing method may for instance be used as a diagnostic tool to rate performances of encoders. The more potential problematic blocks an encoder produces the more artefacts will occur. The analyzing method can thus be used as a tool for improving the performances of encoders. Such a diagnostic tool does not exist at this moment. The analyzing method may also be used in an encoder or transcoder to identify potentially affected blocks and re-encode these blocks or replace them or generate an image data stream in which the potentially affected blocks or macroblocks are indicated.

FIG. 13 illustrates an example of a display device in accordance with the invention. The display device comprises a reducer, which in this example comprises parts 1 (artefact detection), 2 (low pass filtering) and part 3 (selection). The display device comprises a receiver 4 for receiving an input signal 5 comprising an image data stream signal. The input signal may comprise an already decoded image data stream 5 or an encoded image data stream 5′. The signal is lead to an input 6. If an encoded signal 5′ is received the display device comprises a decoder 7 for decoding the incoming encoded signal. If the display device comprises a decoder 7 for decoding the incoming encoded signal the encoding parameters may be sent to comparison part 3. During decoding the potentially affected blocks may be provided with flags so that such blocks can be identified in selection step 3. The output is displayed on a display screen 8. A display device in accordance with the invention may be any device for displaying an image including, but not restricted to, TV devices, monitors, PDA, mobile phones.

In short the invention may be described by:

A hither before unknown cause of image artefacts has been identified. Encoders such as MPEG encoders may use two picture structures: Field pictures and frame pictures. For a frame picture both frame and field-based DCT (and other types) of coding may be used. The decision whether to use frame or field based coding is not always made correctly. In the decoded image this leads to an image artefact visible as stripped blocks. The invention reduces, in one aspect of the invention, these artefacts by analyzing the block content on the presence of such artefacts and if the analysis proof the existence of such artefacts applying a vertical low pass filter to the data in the block. In another aspect of the invention encoding parameters are checked for combination of encoding parameters for which the artefact may occur and such blocks are indicated. The invention may be embodied in a method as well as in a device such as a receiver, encoder, decoder, display device etc.

The invention is also embodied in any computer program product for a method or device in accordance with the invention. Under computer program product should be understood any physical realization of a collection of commands enabling a processor—generic or special purpose—, after a series of loading steps (which may include intermediate conversion steps, like translation to an intermediate language, and a final processor language) to get the commands into the processor, to execute any of the characteristic functions of an invention. In particular, the computer program product may be realized as data on a carrier such as e.g. a disk or tape, data present in a memory, data traveling over a network connection—wired or wireless—, or program code on paper. Apart from program code, characteristic data required for the program may also be embodied as a computer program product.

Some of the steps required for the working of the method may be already present in the functionality of the processor instead of described in the computer program product, such as data input and output steps.

The algorithmic components disclosed in this text may in practice be (entirely or in part) realized as hardware (e.g. parts of an application specific IC) or as software running on a special digital signal processor, or a generic processor, etc.

Within the concept of the invention a ‘comparator’, ‘determinator’, ‘reducer’ ‘low-pass filter’ etc are to be broadly understood and to comprise e.g. any piece of hard-ware, any circuit or sub-circuit designed for performing a comparison, determination, reduction, low-pass filtering etc function as described as well as any piece of soft-ware (computer program or sub program or set of computer programs, or program code(s)) designed or programmed to perform a comparison, determination, reduction, low-pass filtering etc operation in accordance with any aspect of the invention as well as any combination of pieces of hardware and software acting as such, alone or in combination, without being restricted to the below given exemplary embodiments. One program or algorithm may combine several functions and several functions may share common elements of one or more programs.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

The word “comprising” does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The invention may be implemented by any combination of features of various different preferred embodiments as described above.

1. A method of processing a compressed image data stream in which method compression artefacts are reduced wherein for a decoded image block or for a group of decoded image blocks at least one difference value (yes count, Gv) is determined (1) from differences in pixel data in a vertical direction between adjacent lines and the difference value is compared to a threshold (k*no count, k*Gh) wherein in case the difference value meets the threshold, low pass filtering (2) in vertical direction is applied to the decoded image block or blocks.

2. A method of processing a compressed image data stream as claimed in claim 1, wherein the threshold is a fixed value.

3. A method of processing a compressed image data stream as claimed in claim 1 wherein the threshold (k*no count, k*Gh) is dependent on data comprised within the block.

4. A method of processing a compressed image data stream as claimed in claim 1, wherein the strength of the low pass filtering is dependent on data comprised in the block.

5. A method as claimed in claim 1, wherein the determination of the difference value is preceded by a selection step (3) to select the blocks on which the difference value determination (1) and low pass filtering (2) is to be performed.

6. A method as claimed in claim 5, wherein the selection is performed on the basis on an average luminance or average color content of the block.

7. A method as claimed in claim 5, wherein the selection comprises a consistency check performed with neighboring blocks.

8. A method as claimed in claim 5, wherein the selection step comprises a step in which encoding parameters of the blocks are analyzed.

9. A method as claimed in claim 8, wherein bitstream headers (PrSe, PiSt, fpfd, fmt, dt) are analyzed.

10. A reducer for reducing image artefacts in wherein the reducer comprises a determinator for determining for a or for a group of decoded image blocks at least one difference value (Yes count, Gv) from differences in pixel data in a vertical direction between adjacent lines and a comparator (C) for comparing the at least one difference value is compared to a threshold (k*no count, k*Gh) and a low pass filter to apply low pass filtering (2) in vertical direction to the decoded image block or blocks in case the difference value meets the threshold.

11. A reducer as claimed in claim 10, wherein the reducer comprises a further determinator to determine the threshold (k*no count, ki*Gh) from data comprised in the block.

12. A reducer as claimed in claim 10, wherein the reducer comprises a further determinator to determine the strength of the low pass filtering in dependence on data (Gh) comprised in the block.

13. A reducer as claimed in claim 10, wherein the reducer comprises an analyzer to analyze encoding parameters (PrSe, PiSt, fpfd, fmt, dt).

14. A receiver (4) for receiving a compressed image data stream for displaying an image comprising a reducer as claimed in claim 10.

15. A display device comprising a receiver (4) for receiving a compressed image data stream (5, 5′) for displaying an image on a display screen (8) and a reducer as claimed in claim 10.

16. A transcoder for transcoding a compressed image data stream comprising a reducer as claimed in claim 10.

17. A method for analyzing encoding parameters of an encoded image data stream wherein blocks or macroblocks in a frame picture for which the encoder may have performed a frame or a field encoding are indicated.

18. A method for analyzing encoding parameters of an encoded image data stream as claimed in claim 17, wherein sequence headers and picture headers (PrSe, PiSt, fpfd, fmt, dt) of the encoded video bitstream are analyzed.

19. A method for analyzing encoding parameters of an encoded image data stream as claimed in claim 17, wherein the method comprises generation of indicators (I) in or for the image data stream.

20. Analyzer (AN) for analyzing encoding parameters of an encoded image data stream the analyzer comprising a means for indicating blocks or macroblocks in a frame picture for which the encoder may have performed a frame or a field encoding.

21. Computer program product to be loaded by a computer arrangement, comprising instructions to process a compressed data stream, for a method as claimed in claim 1, when run on a computer, the computer arrangement comprising processing means, the processing means comprising:
a determinator for determining for a decoded image block or for a group of decoded image blocks at least one difference value (yescount, Gv) from differences in pixel data in a vertical direction between adjacent lines and
a comparator (C) for comparing the difference value to a threshold (k*no count, k*Gh) and
means for low pass filtering (2) in vertical direction the decoded image block or group of image blocks when the difference value meets the threshold.

22. Computer program product to be loaded by a computer arrangement, comprising instructions to process a compressed data stream, for a method as claimed in claim 17, when run on a computer, the computer arrangement comprising processing means, the processing means comprising an analyzer for analyzing encoding parameters of an encoded image data stream wherein blocks or macroblocks in a frame picture for which the encoder may have performed a frame or a field encoding are indicated.

23. Signal comprising an image data stream which signal comprises indicators I indicating for blocks or groups of blocks the possibility a wrong frame/field encoding.

24. Signal for an image data stream which signal comprises indicators I indicating for blocks or groups of blocks the possibility a wrong frame/field encoding.
